(19) United States
(12) Patent Application Publication
(10) Pub. No.: US 2014/0059497 A1
(43) Pub. Date: Feb. 27, 2014

(54) COORDINATED MULTI-LEVEL CAROUSEL

(71) Applicants: Erik J. Burckart, Raleigh, NC (US); Michael P. Etgen, Cary, NC (US); Andrew J. Ivory, Wake Forest, NC (US); David M. Stecher, Durham, NC (US)

(72) Inventors: Erik J. Burckart, Raleigh, NC (US); Michael P. Etgen, Cary, NC (US); Andrew J. Ivory, Wake Forest, NC (US); David M. Stecher, Durham, NC (US)

(73) Assignee: INTERNATIONAL BUSINESS MACHINES CORPORATION, Armonk, NY (US)

(21) Appl. No.: 13/590,811

(22) Filed: Aug. 21, 2012

(51) Int. Cl. G06F 3/048

(52) U.S. Cl. 715/854

(57) ABSTRACT

A method for a multi-level carousel in a user interface is described. The method includes displaying the multi-level carousel in the user interface. The multi-level carousel includes a top level carousel and a sublevel carousel. The method also includes displaying data in the top level carousel and the sublevel carousel in the user interface. Data in the top level carousel has a relationship with data in the sublevel carousel according to a relationship mapping. The method also includes linking navigation of the top level carousel and the sublevel carousel. Linking the navigation includes modifying data shown on the user interface for the top level carousel and the sublevel carousel according to the relationship mapping in response to an input to navigate data shown on the user interface for one of the top level carousel and the sublevel carousel.

### BACKGROUND

Electronic data may include a variety of relationships between items and groups of items stored on an electronic data store. Electronic data may include folders and files stored on the data store using a mapping structure, such as a hierarchy, such that the data may be organized into two or more levels. The electronic data may be displayed on a user interface to allow users to view, navigate, and/or manipulate the items and the corresponding relationships.

In some datasets, relationships between items or groups of items are important or essential for accurate representation of the data. Some examples include airlines mapped to available flight listings, businesses mapped to their respective inventories, and different employees mapped to the machines the employees use. Such applications can provide valuable information to the users by displaying the data and the corresponding relationships, and by allowing the users to navigate and/or manipulate the data.

### SUMMARY

Embodiments of a method are described. In one embodiment, the method is a method for a multi-level carousel in a user interface is described. The method includes displaying the multi-level carousel in the user interface. The multi-level carousel includes a top level carousel and a sublevel carousel. The method also includes displaying data in the top level carousel and the sublevel carousel in the user interface. Data in the top level carousel has a relationship with data in the sublevel carousel according to a relationship mapping. The method also includes linking navigation of the top level carousel and the sublevel carousel. Linking the navigation includes modifying data shown on the user interface for the top level carousel and the sublevel carousel according to the relationship mapping in response to an input to navigate data shown on the user interface for one of the top level carousel and the sublevel carousel. Other embodiments of the method, a system, and a computer program product are also described.

Other aspects and advantages of embodiments of the present invention will become apparent from the following detailed description, taken in conjunction with the accompanying drawings, illustrated by way of example of the principles of the invention.

### BRIEF DESCRIPTION OF THE DRAWINGS

FIG. 1 depicts a schematic diagram of one embodiment of a multi-level carousel system.

FIG. 2 depicts a schematic diagram of one embodiment of a multi-level carousel.

FIG. 3 depicts a schematic diagram of one embodiment of a multi-level carousel.

FIG. 4 depicts a schematic diagram of one embodiment of a multi-level carousel.

FIG. 5 depicts a schematic diagram of one embodiment of a multi-level carousel.

FIG. 6 depicts a flowchart diagram of one embodiment of a method for a multi-level carousel in a user interface.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

While many embodiments are described herein, at least some of the described embodiments present a system and method for a multi-level carousel in a user interface. More specifically, the system displays a set of electronic data in a multi-level carousel configuration according to a relationship mapping of the data. Navigation for each level of the carousel is linked to the other levels of the carousel according to the relationship mapping, such that navigating through one of the levels may affect the current view or selection in another level.

A mapping structure may include any type of relationship between at least two items in a data store, such as a hierarchy or one-to-one mapping between items. While many conventional systems provide an interface for users to navigate data stores that contain data in such a mapping structure, many of the solutions involve tree-based representations of the data structure. Tree-based representations may allow users to view the contents of the tree, whether all at once or by navigating through nodes of the tree. However, navigating through such tree structures does not linking the navigation of each level to the other levels, such that navigating one level of the data structure in a tree structure does not have any effect on the navigation of other levels. Consequently, a system that links navigation of different levels of a data structure in a multi-level carousel may provide a clean, simple way for a user to view and/or manipulate data in the data structure.

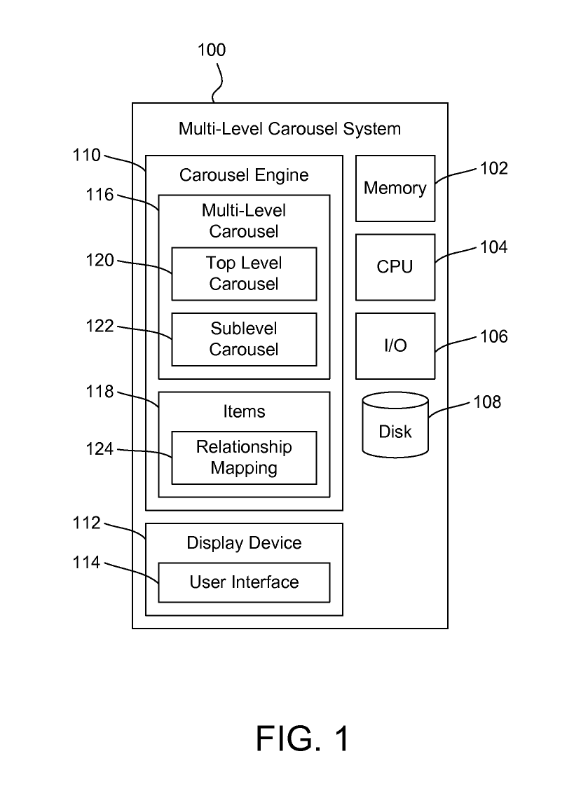

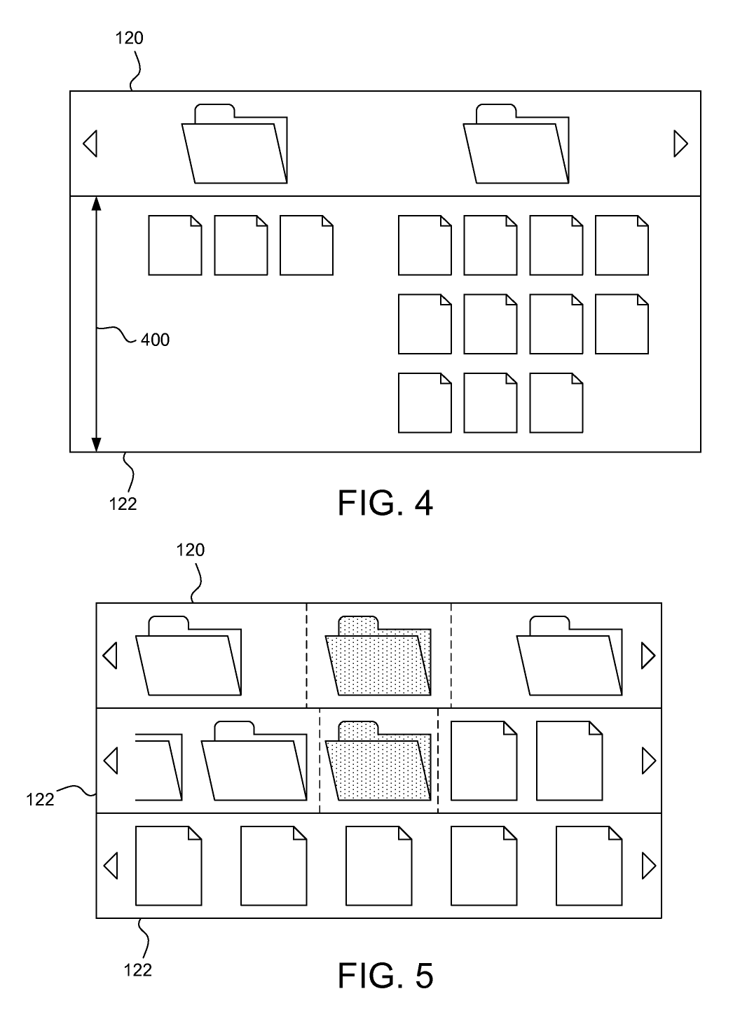

FIG. 1 depicts a schematic diagram of one embodiment of a multi-level carousel system. The depicted multi-level carousel system 100 includes various components, described in more detail below, that are capable of performing the functions and operations described herein. In one embodiment, at least some of the components of the multi-level carousel system 100 are implemented in a computer system. For example, the functionality of one or more components of the multi-level carousel system 100 may be implemented by computer program instructions stored on a computer memory device 102 and executed by a processing device 104 such as a CPU. The multi-level carousel system 100 may include other components, such as input/output devices 106, a disk storage drive 108, a carousel engine 110, and a display device 112. Some or all of the components of the multi-level carousel system 100 may be stored on a single computing device 104 or on a network of computing devices 104, including a wireless communication network. The message subscription system 100 may include more or fewer components or subsystems than those depicted herein. In some embodiments, the multi-level carousel system 100 may be used to implement the methods described herein as depicted in FIG. 4.

The display device 112 is configured to display a user interface 114. For example, the display device 112 may be a computer monitor or other output display device 112 for a computing device that allows a user to interact with the user interface 114. The computing device may be any computing device, such as a desktop computer, a laptop computer, a mobile device, or any other computing device capable of receiving user input to a user interface 114 presented on a display device 112. The user interface 114 may be part of an operating system or part of an application within an operating system. The user interface 114 may receive input from the user via any type of input, including, but not limited to, a mouse, a track pad, a touch display, voice command, and gestures.

In one embodiment, the carousel engine is configured to display a multi-level carousel 116 in the user interface 114, the multi-level carousel 116 having at least two levels or carousels. The multi-level carousel 116 may include as many levels as correspond to relationship mappings 124 for data items 118 to be displayed on the carousel. Data displayed in the carousels may include any format that allows a user to view the data in an organized way and interact with the data. The relationship mappings 124 may include any relationships between two or more data items 118 or between groups of data items 118, including hierarchical relationships, one-to-one relationships, and any other relationship that may be represented using a multi-level carousel 116. Each level may include data corresponding to a particular “level” of data according to the relationship mappings 124. Some examples of relationship mappings 124 may include folders which contain files or additional folders, air carrier shippers and their corresponding shipments, airlines and their corresponding available flights, businesses mapped to their corresponding inventories, employees mapped to their corresponding work machines, and other relationship mappings 124.

The carousel engine is also configured to link navigation of the carousel levels, such that manipulating one level of the carousel manipulates other levels of the carousel based on the relationship mapping 124. In one embodiment including a top level carousel 120 and a sublevel carousel 122, the carousel engine modifies the data shown on the user interface 114 for the top level carousel 120 or the sublevel carousel 122 according to the relationship mapping 124 in response to rotating/changing the data shown on the user interface 114 for either of the carousel levels. For example, rotating the top level carousel 120 to select a specific item 118 in the top level carousel 120 changes the contents of the sublevel carousel 122, and any additional sublevels, to include items 118 mapped to the selected item.

The multi-level carousel 116 may be displayed on the user interface 114 in any orientation. In some embodiments, the carousel levels are displayed together in a group in a single portion of the user interface 114. In other embodiments, the carousel levels may be displayed in different portions of the user interface 114. The carousel levels may be displayed side-by-side, one above another or a combination of both, depending on the desired implementation. In one embodiment including data in a top level carousel 120 that has a parent relationship with data in a sublevel carousel 122, multiple sublevel carousels 122 may be displayed for each item 118 visible in the top level carousel 120, such that as the top level carousel 120 rotates, the sublevel carousels 122 (rather than just the data shown in the sublevel carousels 122) rotate with the top level carousel 120 or are otherwise updated to reflect the change. Other configurations of a multi-level carousel 116 not described herein may be used in the multi-level carousel system 100.

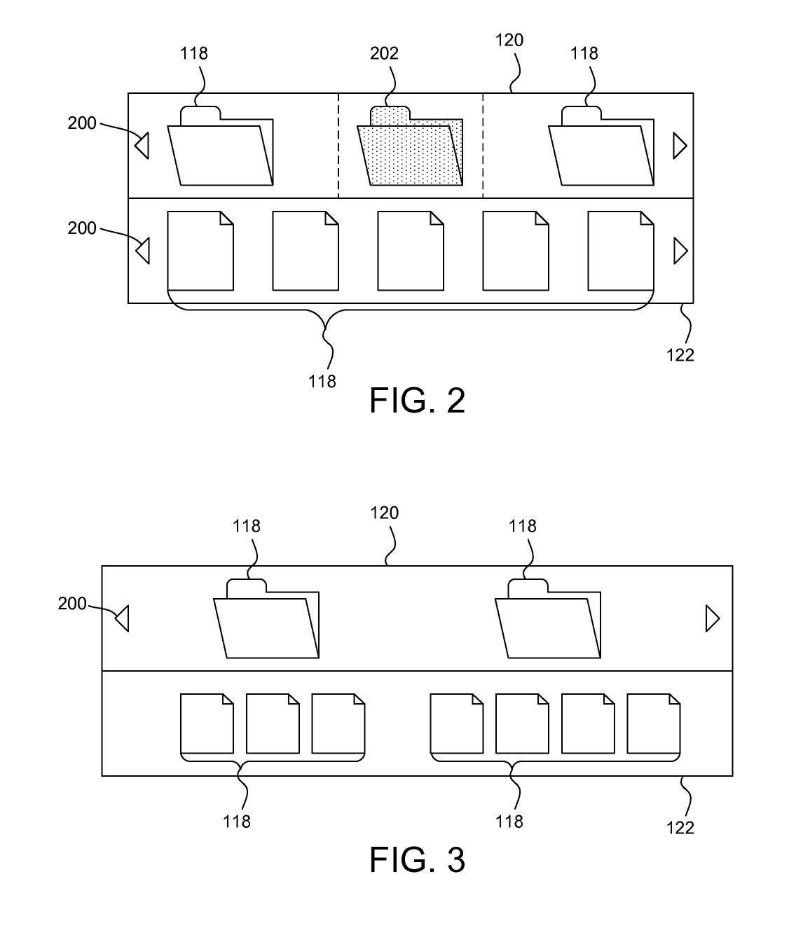

FIGS. 2-5 depict schematic diagrams of various embodiment of a multi-level carousel 116. While the multi-level carousel system 100 is depicted in conjunction with the multi-level carousel 116 of FIGS. 2-5, the multi-level carousel system 100 may be used in conjunction with any type of multi-level carousel 116.

In one embodiment, the multi-level carousel 116 includes a top level carousel 120 and a sublevel carousel 122. Data in the top level carousel 120 may have a parent relationship with data in the sublevel carousel 122. For example, the top level carousel 120 may include several file folders, each containing one or more files. The files contained in the file folders may be displayed in the sublevel carousel 122. For example, if the user selects a given folder, the files contained in the selected folder are displayed in the sublevel carousel 122. The user may rotate the sublevel carousel 122 to navigate through the contents of the selected folder. The multi-level carousel 116 may include separate navigation controls 200 for the top level carousel 120 and the sublevel carousel 122.

In one embodiment, the user is able to rotate from the selected folder in the top level carousel 120 to another folder in the top level carousel 120 by rotating the sublevel carousel 122. For example, the user may rotate the sublevel carousel 122 to a content boundary of the selected folder. When the sublevel carousel 122 reaches the content boundary, and the user attempts to navigate beyond the content boundary by rotating the sublevel carousel 122 in the corresponding direction, the top level carousel 120 may display the folder in the corresponding direction of the top level carousel 120 in a selected position as the new selected folder. When the top level carousel 120 displays a new selected folder, the data in the sublevel carousel 122 changes to display the data from the new selected folder.

In the embodiment of FIG. 3, the multi-level carousel 116 has a single navigation control for the top level carousel 120 and the sublevel carousel 122. Consequently, the navigation of the top level carousel 120 and sublevel carousel 122 is tied together, such that rotating either the top level carousel 120 or the sublevel carousel 122 rotates the other level simultaneously. The data in the sublevel carousel 122 may be displayed directly below the corresponding parent/related data in the top level carousel 120. The sublevel carousel 122 may display all of the items 118 in the sublevel carousel 122 associated with each item 118 currently displayed in the top level carousel 120. This may allow the user to navigate the data in the top level carousel 120 while simultaneously viewing the corresponding data in the sublevel carousel 122.

In some embodiments, the top level carousel 120 displays one item 118 at a time, and the sublevel carousel 122 displays only the items 118 associated with the selected item 202 in the top level carousel 120. Swapping out the selected item 202 in the top level carousel 120 by rotating the top level carousel 120 swaps out the corresponding items 118 in the sublevel carousel 122 simultaneously. In another embodiment, the top level carousel 120 displays multiple items 118 in the top level carousel 120, and the sublevel carousel 122 displays the items 118 corresponding to each of the displayed items 118 from the top level carousel 120. The system 100 may make a determination of the number of items 118 that me displayed in the top level carousel 120 at one time by monitoring the display space available, the total number of items 118 in the top level carousel 120, and the number of corresponding items 118 in the sublevel carousel 122.

In the embodiment of FIG. 4, the system 100 is configured to set or change a vertical dimension 400 of the sublevel carousel 122 based on the number of items 118 in the sublevel carousel 122 that correspond to a selected item 202 in the top level carousel 120. For example, if a selected item 202 in the top level carousel 120, such as a folder, contains or is associated with a small number of items 118, the sublevel carousel 122 may be displayed with a default dimension. If the selected item 202 in the top level carousel 120 contains or is associated with a large number of items 118, such that the items 118 do not fit horizontally within the default dimension of the sublevel carousel 122, the system 100 may set the vertical dimension 400 of the sublevel carousel 122 to be greater than the default dimension.

As the user rotates the multi-level carousel 116, the vertical dimension 400 of the sublevel carousel 122 may change as necessary depending on the number of items 118 that are to be displayed in the sublevel carousel 122. The vertical dimension 400 of the sublevel carousel 122 may increase or decrease as the user rotates the top level carousel 120 and selects different items 118. The vertical dimension 400 of the sublevel carousel 122 may increase for a displayed/selected item 202 in the top level carousel 120 containing a large number of items 118, and the vertical dimension 400 of the sublevel carousel 122 may decrease for an item 118 in the top level carousel 120 containing a small number of items 118.

In the embodiment of FIG. 5, the multi-level carousel 116 displays multiple sublevel carousels 122 under the top level carousel 120. The multi-level carousel 116 may show any number of carousels. The number of carousels shown may depend on the number of levels associated with the relationship mappings 124, the amount of display space in the user interface 114, the number of items 118 in different levels selected by the user for navigation, and other criteria. For example, the multi-level carousel 116 may initially display only the top level carousel 120 before the user has selected an item 118 in the top level carousel 120. When the user selects an item 118 (such as a folder), the multi-level carousel 116 may then also display the sublevel carousel 122 with the data corresponding to the selected item 202. If the user selects an item 118 from the sublevel carousel 122 that has related data (such as by selecting a subfolder containing additional documents), the multi-level carousel 116 may display an additional sublevel carousel 122 with the data corresponding to the selected subfolder or item. Thus, the multi-level carousel 116 displays the top level carousel 120, sublevel carousel 122, and an additional sublevel carousel 122.

Because the navigation of the carousel levels is linked, the user may alter what is displayed in any of the carousel levels by rotating any of the carousel levels. For example, if the user rotates the top level carousel 120 to a new selected item 202, the sublevel carousel 122 may be changed to include the corresponding data for the new selected item 202, and the additional sublevel carousel 122 may be hidden until a new subfolder or item 118 is selected from the sublevel carousel 122. In another example, if the user rotates the additional sublevel carousel 122 beyond a content boundary of the additional sublevel carousel 122, the sublevel carousel 122 may rotate to the next proximate item 118 in the sublevel carousel 122. If rotating the additional sublevel carousel 122 beyond the content boundary of the additional sublevel folder causes the sublevel carousel 122 to rotate beyond a content boundary of the sublevel carousel 122 associated with the selected item 202 from the top level carousel 120, the top level carousel 120 may then rotate to the next proximate item in the top level carousel 120. Other embodiments of additional carousel levels or linked navigation may be used in conjunction with the multi-level carousel 116.

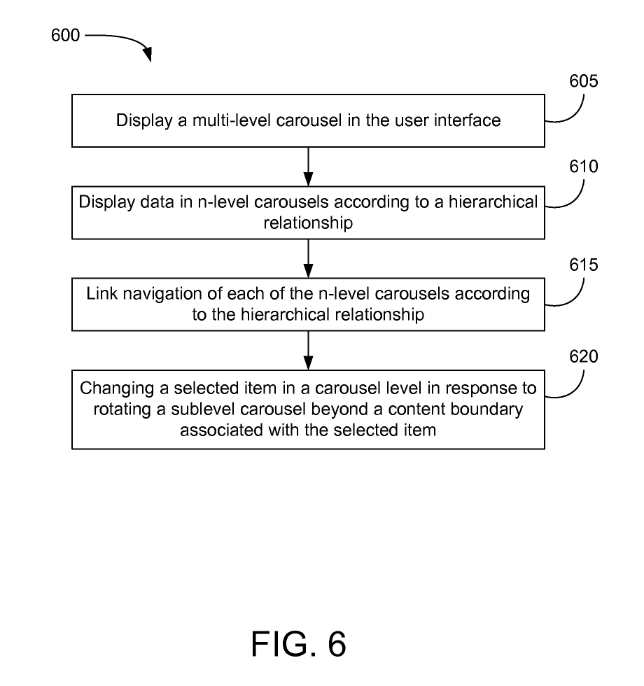

FIG. 6 depicts a flowchart diagram of one embodiment of a method 600 for a multi-level carousel 116 in a user interface 114. Although the method 600 is described in conjunction with the multi-level carousel system 100 of FIG. 1, the method 600 may be used in conjunction with any type of multi-level carousel system 100.

In one embodiment, the multi-level carousel system 100 displays 605 the multi-level carousel 116 in the user interface 114. The multi-level carousel 116 includes a least a top level carousel 120 and a sublevel carousel 122. In one embodiment, the data in the sublevel carousel 122 is displayed directly below each corresponding parent item 118 in the top level carousel 120.

The system 100 displays 610 data in the top level carousel 120 and data in the sublevel carousel 122 in the user interface 114. The data in the top level carousel 120 has a relationship with data in the sublevel carousel 122 according to a relationship mapping 124. In one embodiment, the data in the top level carousel 120 has a parent relationship with the data in the sublevel carousel 122, though the data may have other relationships than those described herein. In some embodiments, the multi-level carousel 116 may include additional carousel levels. In one embodiment, the data in a sublevel carousel 122 may have a parent relationship with the data in an additional carousel level. Additional carousel levels may include parent-child relationships according to the relationship mapping 124.

The system 100 links 615 navigation of the top level carousel 120 and the sublevel carousel 122. Linking the navigation includes modifying data shown on the user interface 114 for the top level carousel 120 and the sublevel carousel 122 according to the relationship mapping 124 in response to an input to navigate data shown on the user interface 114 for either the top level carousel 120 or the sublevel carousel 122. This may allow the user to navigate through multiple levels of related data by using navigation controls 200 for one or more carousel levels.

Navigating data shown on the user interface 114 for the sublevel level carousel may include rotating the sublevel carousel 122 to change which data is shown in the user interface 114 for the sublevel carousel 122 corresponding to the selected item 202 in the top level carousel 120. This may change 620 the selected item 202 in the top level carousel 120 if the sublevel carousel 122 is rotated beyond a content boundary associated with the selected item 202. Changing the selected item 202 in the top level may include rotating the top level carousel 120 to highlight a new selected item 202 in a selected position of the top level carousel 120. The selected position may be any position that indicates that the data shown in the sublevel folder corresponds to the new selected item 202, such as by highlighting the new selected item 202, changing the appearance of the new selected item 202, or changing the position of the new selected item 202 in the top level carousel 120. In one embodiment, the top level carousel 120, the sublevel carousel 122, and any additional carousel levels rotate simultaneously. This may be achieved, for example, by providing a single navigation control for the multi-level carousel 116.

In one embodiment, the system 100 is configured to set a vertical dimension 400 of the sublevel carousel 122 based on the number of items 118 in the sublevel carousel 122. This may allow the sublevel carousel 122 to display all of the items 118 corresponding to a given item 118 in the top level carousel 120 that might not otherwise fit in the horizontal dimensions of the sublevel carousel 122. Other dimensions or aspects of the top level carousel 120, sublevel carousel 122, or other carousel levels may be modified according to various implementations of the multi-level carousel 116.

Embodiments of the invention can take the form of an entirely hardware embodiment, an entirely software embodiment, or an embodiment containing both hardware and software elements. In one embodiment, the invention is implemented in software, which includes but is not limited to firmware, resident software, microcode, etc.

An embodiment of a message subscription system 100 includes at least one processor coupled directly or indirectly to memory elements through a system bus such as a data, address, and/or control bus. The memory elements can include local memory employed during actual execution of the program code, bulk storage, and cache memories which provide temporary storage of at least some program code in order to reduce the number of times code must be retrieved from bulk storage during execution.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Input/output or I/O devices (including but not limited to keyboards, displays, pointing devices, etc.) can be coupled to the system either directly or through intervening I/O controllers. Additionally, network adapters also may be coupled to the system to enable the data processing system to become coupled to other data processing systems or remote printers or storage devices through intervening private or public networks. Modems, cable modems, and Ethernet cards are just a few of the currently available types of network adapters.

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A computer program product, comprising:
a computer readable storage medium to store a computer readable program, wherein the computer readable program, when executed by a processor within a computer, causes the computer to perform operations for a multi-level carousel in a user interface, the operations comprising:
displaying the multi-level carousel in the user interface, wherein the multi-level carousel comprises a top level carousel and a sublevel carousel;
displaying data in the top level carousel and the sublevel carousel in the user interface, wherein data in the top level carousel comprises a relationship with data in the sublevel carousel according to a relationship mapping; and
linking navigation of the top level carousel and the sublevel carousel, wherein linking the navigation comprises modifying data shown on the user interface for the top level carousel and the sublevel carousel according to the relationship mapping in response to an input to navigate data shown on the user interface for one of the top level carousel and the sublevel carousel.

2. The computer program product of claim 1, wherein the data in the top level carousel comprises a parent relationship with the data in the sublevel carousel.

3. The computer program product of claim 2, wherein the multi-level carousel further comprises at least one additional carousel level, wherein the data in the sublevel carousel comprises a parent relationship with data in the additional carousel level.

4. The computer program product of claim 1, wherein navigating data shown in the user interface for the sublevel carousel further comprises:
rotating the sublevel carousel to change which data is shown in the user interface for the sublevel carousel corresponding to a selected item in the top level carousel; and
changing the selected item in the top level carousel in response to rotating the sublevel carousel beyond a content boundary associated with the selected item.

5. The computer program product of claim 4, wherein changing the selected item in the top level carousel further comprises:
rotating the top level carousel to highlight a new selected item in a selected position of the top level carousel.

6. The computer program product of claim 1, wherein displaying the data in the top level carousel and the sublevel carousel further comprises displaying the data in the sublevel carousel directly below each corresponding parent item in the top level carousel, wherein the top level carousel and the sublevel carousel rotate simultaneously.

7. The computer program product of claim 1, wherein the computer readable program, when executed on the computer, causes the computer to perform additional operations, comprising:
setting a vertical dimension of the sublevel carousel based on a number of items in the sublevel carousel.

8. A method for a multi-level carousel in a user interface, the method comprising:
displaying the multi-level carousel in the user interface, wherein the multi-level carousel comprises a top level carousel and a sublevel carousel;
displaying data in the top level carousel and the sublevel carousel in the user interface, wherein data in the top level carousel comprises a relationship with data in the sublevel carousel according to a relationship mapping; and
linking navigation of the top level carousel and the sublevel carousel, wherein linking the navigation comprises modifying data shown on the user interface for the top level carousel and the sublevel carousel according to the relationship mapping in response to an input to navigate data shown on the user interface for one of the top level carousel and the sublevel carousel.

9. The method of claim 8, wherein the data in the top level carousel comprises a parent relationship with the data in the sublevel carousel.

10. The method of claim 9, wherein the multi-level carousel further comprises at least one additional carousel level, wherein the data in the sublevel carousel comprises a parent relationship with data in the additional carousel level.

11. The method of claim 8, wherein navigating data shown in the user interface for the sublevel carousel further comprises:
rotating the sublevel carousel to change which data is shown in the user interface for the sublevel carousel corresponding to a selected item in the top level carousel; and
changing the selected item in the top level carousel in response to rotating the sublevel carousel beyond a content boundary associated with the selected item.

12. The method of claim 11, wherein changing the selected item in the top level carousel further comprises:
rotating the top level carousel to highlight a new selected item in a selected position of the top level carousel.

13. The method of claim 8, wherein displaying the data in the top level carousel and the sublevel carousel further comprises displaying the data in the sublevel carousel directly below each corresponding parent item in the top level carousel, wherein the top level carousel and the sublevel carousel rotate simultaneously.

14. The method of claim 8, further comprising setting a vertical dimension of the sublevel carousel based on a number of items in the sublevel carousel.

15. A multi-level carousel system, the method comprising:
a display device comprising a user interface; and
a carousel engine configured to:
display a multi-level carousel in the user interface, wherein the multi-level carousel comprises a top level carousel and a sublevel carousel;
display data in the top level carousel and the sublevel carousel in the user interface, wherein data in the top level carousel comprises a relationship with data in the sublevel carousel according to a relationship mapping; and
link navigation of the top level carousel and the sublevel carousel, wherein linking the navigation comprises modifying data shown on the user interface for the top level carousel and the sublevel carousel according to the relationship mapping in response to an input to navigate data shown on the user interface for one of the top level carousel and the sublevel carousel.

16. The system of claim 15, wherein the multi-level carousel further comprises at least one additional carousel level, wherein the data in the sublevel carousel comprises a parent relationship with data in the additional carousel level.

17. The system of claim 15, wherein the carousel engine is further configured to:
rotate the sublevel carousel to change which data is shown in the user interface for the sublevel carousel corresponding to a selected item in the top level carousel; and
change the selected item in the top level carousel in response to rotating the sublevel carousel beyond a content boundary associated with the selected item.

18. The system of claim 17, wherein changing the selected item in the top level carousel further comprises:
rotating the top level carousel to highlight a new selected item in a selected position of the top level carousel.

19. The system of claim 15, wherein the carousel engine is further configured to display the data in the sublevel carousel directly below a corresponding related item in the top level carousel, wherein the top level carousel and the sublevel carousel rotate simultaneously.

20. The system of claim 15, wherein the carousel engine is further configured to set a vertical dimension of the sublevel carousel based on a number of items in the sublevel carousel.
